(19) United States
(12) Patent Application Publication
(10) Pub. No.: US 2017/0335037 A1
(43) Pub. Date: Nov. 23, 2017

(54) VULCANIZABLE COMPOSITIONS CONTAINING EPOXY GROUP-CONTAINING ETHYLENE-VINYL ACETATE COPOLYMERS

(71) Applicant: ARLANXEO DEUTSCHLAND GMBH, DORMAGEN (DE)

(72) Inventors: FRANK TASCHNER, MONHEIM (DE); SUSANNA LIEBER, KAISERSLAUTERN (DE); ULRICH FRENZEL, DORMAGEN (DE); RAINER KALKOFEN, LEVERKUSEN (DE); ERIC ARNOLDI, LEVERKUSEN (DE); ANDREAS ROOS, DUSSELDORF (DE)

(73) Assignee: ARLANXEO DEUTSCHLAND GMBH, DORMAGEN (DE)

(21) Appl. No.: 15/522,833

(22) PCT Filed: Oct. 14, 2015
(86) PCT No.: PCT/EP2015/073788

§ 371 Date: Apr. 28, 2017

(30) Foreign Application Priority Data
Oct. 30, 2014 (EP) 14191162.8

(51) Int. Cl. C08F 218/08; C08J 3/24

(52) U.S. Cl. CPC C08F 218/08; C08J 3/24; C08J 2331/04

(57) ABSTRACT

The invention relates to vulcanizable compositions comprising epoxy group-containing ethylene-vinyl acetate copolymers having a content of copolymerized vinyl acetate of at least 35% by weight, a content of copolymerized ethylene of at least 10% by weight, and also a content of copolymerized epoxy group-containing monomers of 0.5 to 6.2% by weight, a crosslinking aid and a crosslinker having a molar mass of less than 2000 g/mol, in the form of a polycarboxylic acid, a polycarboxylic ester, a polycarboxylic anhydride or a mixture thereof, and also a process for vulcanization thereof, the vulcanizates thereby obtainable and use thereof.

The invention relates to vulcanizable compositions comprising epoxy group-containing ethylene-vinyl acetate copolymers having a content of copolymerized vinyl acetate of at least 35% by weight, a content of copolymerized ethylene of at least 10% by weight, and also a content of copolymerized epoxy group-containing monomers of 0.1 to 6.2% by weight, a crosslinking aid and a crosslinker having a molar mass of less than 2000 g/mol, in the form of a polycarboxylic acid, a polycarboxylic ester, a polycarboxylic anhydride or a mixture thereof, a process for vulcanization thereof and vulcanizates thereof.

“Copolymers” in the sense of the invention encompass all copolymers which comprise copolymerized units of at least three different monomers.

Ethylene-vinyl acetate copolymers (EVM) having a vinyl acetate (VA) content of at least 35% by weight are industrially produced rubbers from which vulcanizates may be prepared by radical cross-linking, which are characterized in particular by good oil and media resistance, excellent ageing resistance and also high flame retardancy. In this case, commercial peroxide initiators especially are used for the free-radical crosslinking, although crosslinking using high-energy radiation is also possible and customary.

A known problem of such vulcanized EVM rubbers is their inadequate performance in applications with repeated and dynamic stress. For many applications, for example fatigue resistance and tear propagation resistance of rubber parts composed of EVM rubbers are inadequate.

A further known problem is that the rubber parts composed of EVM rubber have a very low tear initiation and tear propagation resistance in the warm state after the vulcanization, which can easily lead to damage and/or destruction of the manufactured rubber part during removal from the mould. As a way out, the use of two peroxides in combination has been proposed in the literature, wherein the rubber parts are demoulded in an undercrosslinked state and are then crosslinked with the aid of a second peroxide, effective at a higher temperature (see: Bergmann, G.; Kelbch, S.; Fischer, C.; Magg, .H; Wrana, C., Gummi, Fasern, Kunstetoffe [Rubber, Fibres, Plastics] Volume 61 Issue 8 pages 490-497, 2008. A disadvantage, however, is the high expenditure in terms of personnel, materials and time, especially as both crosslinking steps must be operated oxygen-free in order to prevent the rubber surfaces becoming tacky during the vulcanization). This phenomenon of tacky rubber surfaces after peroxide vulcanization under contact with air, i.e. oxygen, is a further general problem, which also impairs the processing of EVM rubbers and limits the applicability thereof. In addition, volatile decomposition products of the peroxide crosslinker can lead to bubble formation in the rubber.

An additional known problem is the high tackiness of many EVM mixtures, which impairs processing and frequently makes it necessary to use processing aids in high dosages. These may have undesired side effects, such as exudation, mould soiling and/or reduced budding tack.

Ethylene and vinyl acetate can be tree-radically polymerized in a known manner in different proportions with statistical distribution of the copolymerized monomer units. The copolymerization can generally be carried out by emulsion polymerization, solution polymerization or high-pressure bulk polymerization.

Ethylene-vinyl acetate copolymers having a vinyl acetate content of at least 30 wt % can be prepared, for example, by a solution polymerization process at moderate pressures. In this case, the polymerization is initiated with the aid of initiators which undergo free-radical decomposition. Free-radically decomposing initiators are understood to mean especially hydroperoxides, peroxides and also azo compounds, such as ADVN (2′s-azobis(2,4-dimethylvaleronitrile)). The process is customarily carried out at temperatures in the range from 30 to 150° C., under a pressure in the range from 40 to 1000 bar. Solvents used are, for example, tert-butanol or mixtures of tert-butanol, methanol and hydrocarbons in which the polymers also remain in solution during the polymerization process.

EP 0 374 666 B1 also describes a process for preparing ethylene/vinyl ester copolymers having increased resistance to organic solvents, fuels and oils and high flexibility even at low temperatures. Described therein, inter alia, is an ethylene-vinyl acetate-glycidyl methacrylate copolymer which is prepared by a solution polymerization process conducted continuously in a cascade, with defined parameters (solvent content, pressure, temperature regime, conversion), the copolymer having a glycidyl methacrylate content of 8.5% by weight and a mooney viscosity of 14 (ML (1+4) 100° C.). Vulcanization of these products is not described in the patent, however it is mentioned that the polymers prepared could be crosslinked using peroxide, and optionally via functional groups such as —CO₂H, —OH or epoxides, amine or ionically via metal ions and after vulcanization would show low bubble formation and better demouldability when heated than the products from the prior art.

In the preparation of an ethylene-vinyl acetate-glycidyl methacrylate copolymer described in EP 0 374 666 B1, the total amount of the free-radically decomposing initiator together with the total amount of glycidyl methacrylate (GMA) is metered in, whereupon the polymerization is started, i.e. all the glycidyl methacrylate is present in the reaction solution at the start of the polymerization reaction. In said document, no statements are made about the uniformity of the polymer. The physicomechanical properties of the copolymer and compounding of the same are not described.

EP 2 565 229 A1 describes the preparation of an ethylene-vinyl acetate-glycidyl methacrylate copolymer having a glycidyl methacrylate content of 6.7% by weight, wherein a portion of the glycidyl methacrylate is metered in after the start of the reaction. In this case, no statements are made about the uniformity of the polymer. The physicomechanical properties of the copolymer are not described, only compounding with carboxylated NBR. However, the use of economically unattractive and complex to process carboxylated NBR distinctly limits the applicability in practice, and there further exists the danger of formation of ozone cracks due to the double bonds in the main chain of the NBR.

Experiments on the crosslinking of a mixture of a copolymer according to EP 0 374 666 B1 with a low molecular weight crosslinker and filler led to unsatisfactory vulcanizate properties with respect to tensile strength, modulus and compression set.

Crosslinking experiments with a mixture of the copolymer described in EP 2 585 229 A1 with a low molecular weight crosslinker and filler led, on the other hand, to an inadequate elongation at break.

DE 3525695 describes the vulcanization of epoxy group-containing acrylic elastomers with polycarboxylic acids or polycarboxylic anhydrides and either a quaternary ammonium or phosphonium salt. Neither the addition of the epoxy group-containing monomer after the start of polymerization nor an improved demouldability or improvement of the dynamic properties is mentioned. The polymers disclosed in this document comprise—as well as those in U.S. Pat. No. 4,303,560—a high proportion of acrylates, which results, at least without additional complex post-curing, in unsatisfactory values for tensile strength, elongation at break and compression set.

U.S. Pat. No. 3,875,255 discloses high-pressure polymerized glycidyl methacrylate-containing ethylene-vinyl acetate copolymers, which are however very short-chained, which is reflected in the high melt flow index of 60 g/10 minutes. The polymers are suitable as carrier polymers for grafting of methacrylates for impact resistance modification, but not for preparing vulcanizable compositions having good tensile strength, elongation at break and compression set.

The object of the present invention consisted in providing ethylene-vinyl acetate copolymers comprising vulcanizable compositions which maintain or improve as many of the following properties as possible compared to the prior art: processing reliability, low tackiness and good storage stability, and also excellent mechanical and dynamic properties, good heat ageing resistance, weather and ozone resistance and low compression sets of the vulcanizates obtained therefrom,

Epoxy group-containing ethylene-vinyl acetate copolymers used according to the invention have a vinyl acetate content of at least 35% by weight, preferably at least 40% by weight, particularly preferably at least 45% by weight and especially preferably at least 50% by weight with an ethylene content of at least 10% by weight, preferably at least 15% by weight, particularly preferably at least 20% by weight and especially preferably at least 25% by weight, based on the epoxy group-containing ethylene-vinyl acetate copolymer. It is evident here to those skilled in the art that the values based on the copolymer, such as vinyl acetate content, ethylene content, etc., mean the content of repeating units which are derived from the respective monomers.

To illustrate the patent application, 4 figures are attached:

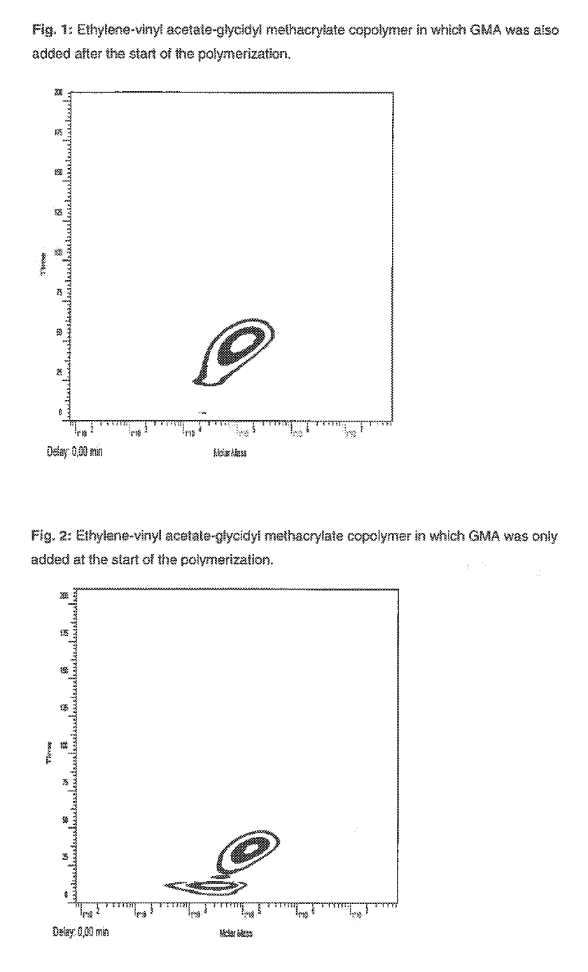

FIG. 1: Ethylene-vinyl acetate-glycidyl methacrylate copolymer in which GMA was also added after the start of the polymerization.

FIG. 2: Ethylene-vinyl acetate-glycidyl methacrylate copolymer in which GMA was only added at the start of the polymerization.

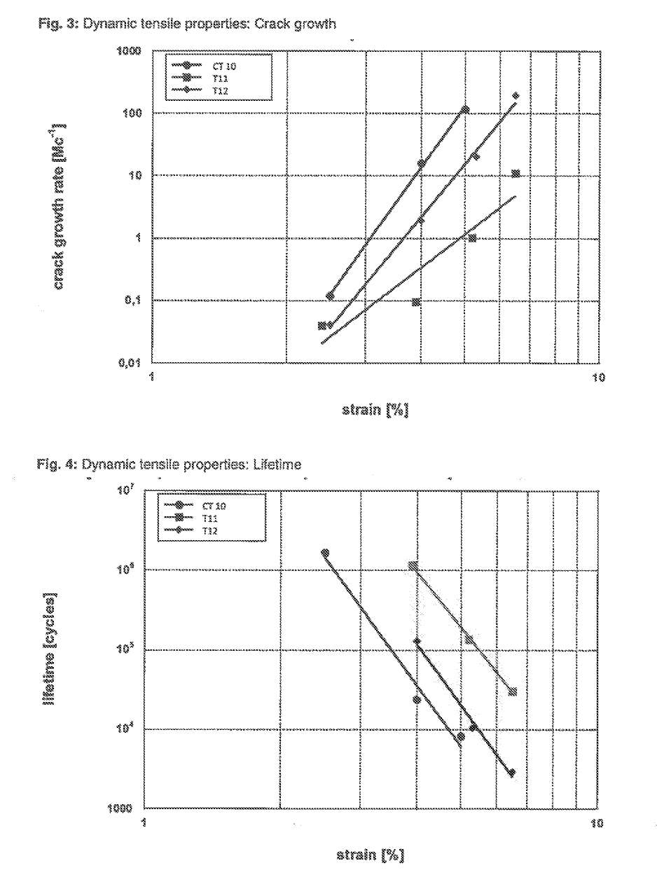

FIG. 3: Dynamic tensile properties: Crack growth

FIG. 4: Dynamic tensile properties: Lifetime

The epoxy group-containing ethylene-vinyl acetate copolymer used according to the invention has a minimum content of repeating units derived from one or more epoxy group-containing monomers of 0.1% by weight, preferably 0.5% by weight and particularly preferably 0.8% by weight and a maximum content of said monomers of 6.2% by weight, preferably 5.0% by weight and particularly preferably 4.5% by weight, based in each case on the epoxy group-containing ethylene-vinyl acetate copolymer. Preferably only one type of epoxy group-containing monomer is present.

The epoxy group-containing ethylene-vinyl acetate copolymer used according to the invention, after vulcanization with glutaric acid and tetrabutylammonium bromide, has a stated gel content in % by weight of at least 50% by weight, preferably at least 80% by weight, particularly preferably at least 85% by weight and especially preferably 90 to 100% by weight. The vulcanisation is performed and the gel content is determined by the method described in the experimental section.

Compounds comprising the epoxy group-containing ethylene-vinyl acetate copolymer used according to the invention exhibit improved vulcanization properties and vulcanizate properties. The vulcanizates, moreover, do not have a tendency to become tacky on vulcanization with polyacids and in the presence of oxygen.

The epoxy group-containing ethylene-vinyl acetate copolymer used according to the invention preferably comprises repeating units derived from one or more, particularly preferably from one, epoxy group-containing monomer(s) of the general formula (I)

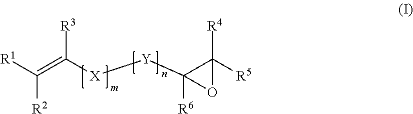

where
m is 0 or 1 and
X is O, O(CR₂)ₚ, (CR₂)ₚO, C(═O)O, C(═O)O(CR₂)ₚ, C(═O)NR, (CR₂)ₚ, N(R), N(R)(CR₂)ₚ, P(R), P(R)(CR₂)ₚ, P(═O)(R), P(═)(R)(CR₂)ₚ, S, S(CR₂)ₚ, S(.═O), S(═O)(CR₂)ₚ, S(═O)₂(CR₂)ₚ or S(═O)₂, wherein R in these radicals may have the same definitions as R¹-R⁶
Y represents repeating units derived from one or more, preferably one, mono- or polyunsaturated monomer(s), comprising conjugated or non-conjugated dienes, alkynes and vinyl compounds, or represents a structural element which derives from polymers comprising polyethers, more particularly polyalkylene glycol ethers and polyalkylene oxides, polysiloxanes, polyols, polycarbonates, polyurethanes, polyisocyanates, polysaccharides, polyesters and polyamides,
n and p are the same or different and are each in the range of 0 to 10 000, preferably 0 to 100 and especially preferably n is in the range from 0 to 100 and at the same time p=0.
R, R¹, R², R³, R⁴, R⁵ and R⁶ are identical or different and are H, a linear or branched, saturated or mono- or polyunsaturated alkyl radical, a saturated or mono- or polyunsaturated carbo- or heterocyclyl radical, aryl, heteroaryl, arylalkyl, heteroarylalkyl, alkoxy, aryloxy, heteroaryloxy, amino, amido, carbamoyl, alkylthio, arylthio, sulphanyl, thiocarboxyl, sulphinyl, sulphono, sulphino, sulpheno, sulphonic acids, sulphamoyl, hydroxylmino, alkoxycarbonyl, F, Cl, Br, I, hydroxyl, phosphonato, phosphinato, silyl, silyloxy, nitrile, borates, selenates, carbonyl, carboxyl, oxycarbonyl, oxysulphonyl, oxo, thioxo, epoxy, cyanates, thiocyanates, isocyanates, thioisocyanates or isocyanides.

Optionally, the definitions stated for the radicals R, R¹ to R⁶ and the repeating units Y of the general formula (I) are in each case singly or multiply substituted.

Preferably, the following radicals from the definitions for R and R¹ to R⁶ have such single or multiple substitution: alkyl, carbocyclyl, heterocyclyl, aryl, heteroaryl, arylalkyl, heteroarylalkyl, alkoxy, aryloxy, alkylthio, arylthio, amino, amido, carbamoyl. F, Cl, Br, I, hydroxyl, phosphonato, phosphinato, sulphanyl, thiocarboxyl, sulphinyl, sulphono, sulphino, sulpheno, sulphamoyl, silyl, silyloxy, carbonyl, carboxyl, oxycarbonyl, oxysulphonyl, oxo, thioxo, borates, selenates and epoxy. Useful substituents include—provided that chemically stable compounds are the result—all definitions that R can assume. Particularly suitable substituents are alkyl, carbocyclyl, aryl, halogen, preferably fluorine, chlorine, bromine or iodine, nitrile (CN) and carboxyl.

Very particular preference is given to using one or more epoxy group-containing monomers of general formula (i), where X, R and R¹ to R⁶ have the definitions mentioned previously for general formula (I), m is equal to 1, p is equal to 1 and n is equal to zero.

Preferred examples of epoxy group-containing monomers glycidilmethyl acrylate are 2-ethylglycidyl acrylate, 2-ethylglycidyl methacrylate, 2-(n-propyl)glycidyl acrylate, 2-(n-propyl)glycidyl methacrylate, 2-(n-butyl)glycidyl acrylate, 2-(n-butyl)glycidyl methacrylate, glycidylmethyl acrylate, glycidylmethyl methacrylate, glycidyl acrylate, (3′,4′-epoxyheptyl)-2 ethyl acrylate, (3′,4′-epoxyheptyl)-2-ethyl methacrylate, 6′,7′-epoxyheptyl acrylate, 6′,7′-epoxyheptyl methacrylate, allyl glycidyl ether, allyl 3,4-epoxyheptyl ether, 8,7-epoxyheptyl allyl ether, vinyl glycidyl ether, vinyl 3,4-epoxyheptyl ether, 3,4-epoxyheptyl vinyl ether, 6,7-epoxyheptyl vinyl ether, o-vinylbenzyl glycidyl ether, m-vinylbenzyl glycidyl ether, p-vinylbenzyl glycidyl ether and 3-vinylcyclohexene oxide.

Most preferably, the epoxy group-containing monomer used is a glycidyl(alkyl)acrylate, preferably glycidyl acrylate and/or glycidyl methacrylate.

The epoxy group-containing ethylene-vinyl acetate copolymers used according to the invention, in addition to repeating units derived from ethylene, vinyl acetate and epoxy group-containing monomers, may also comprise repeating units derived from further monomers, for example, those selected from the group comprising alkyl acrylates having 1 to 8 carbon atoms in the alkyl portion, preferably methyl acrylate, ethyl acrylate, propyl acrylate, n-butyl acrylate, 2-ethylhexyl acrylate and n-octyl acrylate, and the corresponding methacrylates; alkoxyalkyl acrylates having 1 to 4 carbon atoms in each of the alkoxy and alkyl portions, preferably methoxymethyl acrylate, methoxyethyl acrylate, ethoxyethyl acrylate, butoxyethyl acrylate and methoxyethoxyethyl acrylate; polyethylene glycol acrylates and polyethylene glycol methacrylates, vinyl esters, preferably vinyl propionate and vinyl butyrate, vinyl ketones, preferably methyl vinyl ketone and ethyl vinyl ketone, vinyl aromatic compounds, preferably styrene, α-methylstyrene and vinyltoluene; conjugated dienes, preferably butadiene and isoprene; α-monoolefins, preferably propylene and 1-butene; vinyl monomers having a hydroxyl group, preferably β-hydroxyethyl acrylate and 4-hydroxybutyl acrylate; vinyl and vinylidene monomers having a nitrile group, preferably acrylonitrile, methacrylonitrile and 3-cyanoethyl acrylate; unsaturated amide monomers, preferably acrylamide and N-methylmethacrylamide and carbon monoxide. These monomers can each be used individually or in combination. The total proportion of monomers incorporated which are not vinyl acetate, ethylene and epoxy group-containing monomers is less than 15% by weight, preferably less than 10% by weight, particularly preferably less than 5% by weight and especially preferably less than 1% by weight, based on the epoxy group-containing copolymer. In the most preferred embodiment, the epoxy group-containing copolymer is a terpolymer of which the repeating units are derived from ethylene, vinyl acetate and epoxy group-containing monomers. The total content of ethylene, vinyl acetate, epoxy group-containing monomers and the optionally used further monomers mentioned above adds up to 100% by weight, based on the epoxy group-containing copolymer.

The epoxy group-containing monomers are preferably distributed statistically over the polymer chain of the epoxy group-containing ethylene-vinyl acetate copolymer used in accordance with the invention.

It has been shown, surprisingly, that a low content of epoxy group-containing monomer markedly increases the elongation at break. For instance, a vulcanizate based on a glycidyl methacrylate-ethylene-vinyl acetate copolymer having 6.9% by weight glycidyl methacrylate has an elongation at break of 131%, which is why it is unsuitable for many applications, for example, flexible sealing materials. In contrast to this, the vulcanizates based on glycidyl methacrylate-ethylene-vinyl acetate copolymers used according to the invention typically have an elongation at break of more than 150%, preferably more than 160% and particularly preferably more than 210%.

The epoxy group-containing ethylene-vinyl acetate copolymers used according to the invention customarily have mooney viscosities (ML (1+4) 100° C.)≧15 mooney units (MU), preferably ≧17 mooney units, particularly preferably ≧20 mooney units. The mooney viscosity values (ML (1+4) 100° C.) are determined by means of a shearing disc viscometer according to ISO 289 (ISO 289-1:2014-02) at 100° C.

The epoxy group-containing ethylene-vinyl acetate copolymers typically have, furthermore, a polydispersity PDI=M_{w}/Mₙ, (where M_{w} represents the weight average and Mₙ the number average of the molecular weight) in the range of 2 to 10 and preferably in the range of 3 to 6.

The epoxy group-containing ethylene-vinyl acetate copolymers used according to the invention typically have a weight average molar mass Mw in the range of 30 000 g/mol to 400 000 g/mol, preferably 60 000 g/mol to 375 000 g/mol and especially preferably 100 000 g/mol to 348 080 g/mol.

The glass transition temperatures of the epoxy group containing ethylene-vinyl acetate copolymers are in the range from +25° C. to −45° C., preferably in the range from +20° C. to −40° C. and particularly preferably in the range from +15° C. to −35° C. (measured by DSC with a heating rate of 20 K/min).

The epoxy group-containing copolymers used in accordance with the invention are obtainable by a method in which, after the start of the polymerization reaction of ethylene and vinyl acetate, epoxy group-containing monomer is added to the reaction mixture. The reaction mixture can even additionally comprise one or more of the above further monomers at the start, and already comprise epoxy group-containing monomers. In this case, the process is typically carried out as a batch process, e.g. in a stirred tank reactor, or as a continuous process, e.g, in a tank cascade or a tubular reactor. The addition of the epoxy group-containing monomer after the start in a batch process is understood to mean that, after the reaction has started, the epoxy-group-containing monomer is added in portions or continuously, preferably continuously, to the reaction mixture, whereas in a continuous process the epoxy group-containing monomer is added to the reaction mixture at at least one, preferably at more than one position, which is/are boated downstream of the position of the reaction start. The reaction start is in this case the time point or the position at which the polymerization of at least vinyl acetate and ethylene first takes place.

The process for preparing the epoxy group-containing ethylene-vinyl acetate copolymers used according to the invention is preferably carried out as a solution polymerization at temperatures >55° C., particularly preferably >58° C., most preferably at >60° C. The polymerization is typically carried out at pressures of 330-450 bar. The mean residence time is typically in the range of 0.5-12 hours.

In a preferred embodiment, the reaction solution comprises:

i) 1 to 70% by weight, preferably 10 to 60% by weight of ethylene,

ii) 1 to 99% by weight, preferably 30-90% by weight of vinyl acetate and

iii) 0 to 2% by weight of epoxy group-containing monomer

based in each case on the sum total of components i) ii) iii).

The reaction solution typically comprises 20-60% by weight (based on the total mass of the reaction solution) of a polar organic solvent, preferably an alcoholic solvent having one to 4 carbon atoms, particularly preferably tert-butanol.

The reaction solution at the start of the polymerization suitably already comprises epoxy group-containing monomer, preferably in an amount of up to 50% by weight, more preferably up to 33% by weight, particularly preferably up to 25% by weight, especially preferably 10% by weight, and most preferably in the range of 1 to 5% by weight, based on the total amount of epoxy group-containing monomer to be added.

The polymerization is effected by means of a free-radically decomposing initiator, of which the proportion, based on the sum total of components i) ii), is typically 0.001 to 1.5% by weight.

After the start of the polymerization reaction, the epoxy group-containing monomer is metered in without solvent or as a functionalization solution, i.e. as a mixture with vinyl acetate and/or with the process solvent used.

The functionalization solution typically comprises:

iv) 5 to 95% by weight of vinyl acetate and

v) 5 to 95% by weight of epoxy group-containing monomer

based in each case on the sum total of components (iv+v) and also

20-60% by weight of the polar organic solvent, based on the sum totel of the components iv)+v)+polar organic solvent.

The addition of the above functionalization solution has the advantage, compared to the addition without solvent, that the mixture is liquid over a wide temperature range and therefore heating of the storage container and pipelines is generally unnecessary.

The epoxy group-containing monomer is preferably metered in up to at least a time point (in a batch process) or at least a point in the reaction regime (in a continuous process) at which the reaction mixture has a solids content of at least 1% by weight, preferably at least 2% by weight, particularly preferably at least 5% by weight and especially preferably at least 10% by weight.

The metered addition of the functionalization solution takes place preferably continuously in the case of batch polymerizations. The polymerization is particularly preferably carried out continuously in a reactor cascade. In this case, the functionalization solution is typically metered into one, preferably more than one, reactor(s) following the reactor in which the polymerization is started, typically at a temperature in the range of 55° C.-110° C. In the case of carrying out the process in a tubular reactor, the addition is effected at at least one point downstream of the point at which the reaction is started.

The above metered addition of the functionalization solution leads to a higher chemical uniformity of the resulting epoxy group-containing ethylene-vinyl acetate polymer and thus, in the vulcanization with polycarboxylic acid, to a more homogeneous network which is ultimately reflected in a higher gel content.

Without metered addition of the epoxy-containing monomer, as described in EP 0 374 666 B1, the total amount of epoxy-containing monomer is already present at the start of the polymerization, whereby presumably formation of blocks of glycidyl methacrylate takes place, which leads to a non-uniform distribution in the polymer. This manifests, inter alia, in a substantially lower gel content after vulcanization with a dicarboxylic acid.

A high gel content of the vulcanizates containing the copolymer with a dicarboxylic acid is a good indicator of the uniform incorporation of glycidyl methacrylate and correlates with various physical properties of the vulcanizates prepared using these copolymers, such as elongation at break, tensile strength and compression set

2D chromatography also reveals the higher chemical uniformity of the epoxy group-containing ethylene-vinyl acetate copolymers used in accordance with the invention. In this measurement method, the separation is preferably carried out by polarity and hydrodynamic volume. The 2D chromatogram of epoxy group-containing ethylene-vinyl acetate copolymers used in accordance with the invention typically has essentially only one polymer fraction, i.e. the cumulative absorption of the strongest signal is at least 4 times, preferably at least 6 times, particularly preferably at least 10 times and especially preferably at least 50 times greater than the signals of further polymer fractions.

The epoxy group-containing copolymers ued according the the invention having a content of copolymerized vinyl acetate of at least 35% by weight, preferably at least 40% by weight, particularly preferably at least 45% by weight and especially preferably at least 50% by weight, a content of copolymerized ethylene of at least 10% by weight, preferably at least 15% by weight, particularly preferably at least 20% by weight, and especially preferably of 20 to 49% by weight and a content of copolymerized epoxy group-containing monomers of 0.1 to 6.2% by weight, preferably 0.5 to 5.0% by weight, particularly preferably of 0.8 to 4.5% by weight, based in each case on the epoxy group-containing copolymer, have essentially only one polymer fraction in the 2D-chromatogram, with preference according to the method described in the experimental section, i.e. the cumulative absorption of the signal of the largest polymer fraction is at least 4 times, preferably at least 5 times, particularly preferably at least 10 times and especially preferably at least 50 times greater than the cumulative absorption of the signals of the respective further polymer fractions.

By the metered addition of the epoxy-containing monomer or of the functionalization solution, a virtually complete incorporation of the epoxy group-containing monomers can take place with broadly statistical distribution of the epoxy group-containing monomers in the polymer backbone and at the same time formation of blocks of the epoxy group-containing monomers and the formation of pure ethylene-vinyl acetate copolymers are avoided or at least reduced.

Moreover, the conversion at low amounts used of epoxy group-containing monomers could be significantly increased by the above process.

The copolymer solution after completion of the polymerization preferably has less than 300 ppm, preferably less than 200 ppm and most preferably less than 150 ppm of unbound epoxy group-containing monomer.

The polymerization initiators used are preferably peroxydicarbonates, hydroperoxides, peroxides or azo compounds such as 2,2′-azobis(2,4-dimethylvaleronitrile) (ADVN), 2,2′-azoisobutyronitrile (AIBN), 2,2′-azobis(4-methoxy-2,4-dimethylvaleronitrile), 2,2′-azobis(2-methylbutyronitrile), 1,1′-azobis(cyclohexane-1-carbonitrile), dimethyl 2,2′ -azobis(2-methylpropionate), 2,2′-azobis[N-(2-propenyl)-2-methylpropionamide], 1-[(1-cyano-1-methylethyl)azo]formamide, 2,2′-azobis(N-butyl-2-methylpropionamide), 2,2′-azobis(N-cyclohexyl-2-methylpropionamide), 2,2′-azobis[2-(2-imidazolin-2-yl)propane] dihydrochloride, 2,2′-azobis[2-(2-imidazolin-2-yl)propane] disulphate dihydrate, 2,2′-azobis(2-methylpropionamidine) dihydrochloride, 2,2′-azobis[N-(2-carboxyethyl)-2-methylpropionamidine] hydrate, 2,2′-azobis{2-[1-(2-hydroxyethyl)-2-imidazolin-2-yl]propane} dihydrochloride, 2,2′-azobis[2-(2-imidazolin-2-yl)propane], 2,2′-azobis(1-imino-1-pyrrolidino-2-ethylpropane) dihydrochloride, 2,2′-azobis{2-methyl-N-[1,1-bis(hydroxymethyl)-2-hydroxyethyl]propionamide}, 2,2′-azobis[2-methyl-N-(2-hydroxyethyl)propionamide], acetyl cyclohexanesulphonyl peroxide, bis(4-tert-butylcyclohexyl) peroxydicarbonate and bis(2.ethylhexyl) peroxydicarbonate. Particular preference is given to using, as polymerization initiator, 2,2′-azobis(2,4dimethylvaleronitrile) (ADVN), 2,2′-azoisobutyronitrile (AIBN) 2,2′-azobis(4-methoxy-2,4-dimethylvaleronitrile).

The present invention relates to vulcanizable compositions comprising in each case at least one epoxy group-containing copolymer according to the invention, a low molecular weight crosslinker and a crosslinking aid.

The low molecular weight crosslinkers are understood to mean in this case those having a molar mass of less than 2000 g/mol, preferably less than 1000 g/mol, more preferably less than 600 g/mol, particularly preferably less than 400 g/mol and especially preferably less than 200 g/mol. Polycarboxylic polyanhydrides, such as polyazelaic polyanhydride of which the repeating unit is in this mass range, are also included since these convert during the vulcanization into their low molecular weight equivalents.

The low molecular weight crosslinkers are preferably aromatic, aliphatic linear, cycloaliphatic or heterocyclic low molecular weight crosslinkers, preferably in the form of a polycarboxylic acid, a polycarboxylic ester, a polycarboxylic anhydride or a mixture thereof, more preferably an aromatic, aliphatic linear, cycloaliphatic or heterocyclic di-, tri- or tetracarboxylic acid, particularly preferably aliphatic di, tri or tetracarboxylic acid, especially preferably an aliphatic dicarboxylic acid and most preferably glutaric acid, dodecanedioic acid or adipic acid. Mixtures of such compounds are also possible and can be advantageous due to their lower melting point since the mixing is facilitated.

Examples of aliphatic low molecular weight crosslinkers are: malonic acid, succinic acid, glutaric acid, adipic acid, pimelic acid, azelaic acid, sebacic acid, dodecanedioic acid, tridecanetrioic acid, tetradecanedioic acid, octadecanedioic acid, eicosandioic acid, methylmalonic acid, ethylmalonic acid, tetramethylsuccinic acid, 2:2′-dimethylsuccinic acid, malic acid, α-methylmalic acid, α-hydroxyglutaric acid, α-hydroxyadipic acid, oxosuccinic acid, 2-oxoadipic acid, acetylmalonic acid, 2-hydroxyglutaric acid, maleic acid, citraconic acid, glutaconic acid, muconic acid, citric acid, tartaric acid, 1,2,3-propanetricarboxylic acid, 1,2,3-propenetricarboxylic acid, 1,3,5-pentanetricarboxylic acid, cystine, aspartic acid, glutamic acid, 24hydroglutamic acid, iminodiacetic acid, ethylenediaminetetraacetic acid, maleic anhydride, methylmaleic anhydride, succinic anhydride, dodecenyl succinic anhydride, ethylenediaminetetraacetic dianhydride, polyaceiaic polyanhydride, glutaric anhydride, 2,2′dimethylglutaric anhydride, sebacic anhydride, azelaic anhydride, dodecanedioic anhydride, eicosandioic anhydride, citraconic anhydride, cyclomaleic anhydride, diglycolic anhydride and thioglycolic anhydride.

Examples of aromatic low molecular weight crosslinkers are: phthalic acid, 3-methylphthalic acid, terephthalic acid, phthalonic acid, hemipinic acid, benzophenone dicarboxylic acid, phenylsuccinic acid, trimellitic acid, pyromellitic acid, phthalic anhydride, diphenic anhydride, isatoic anhydride, trimellitic anhydride, pyromellitic anhydride, tetrahydrophthalic anhydride, tetrachlorophthalic anhydride and tetrabromophthalic anhydride.

Examples of cycloaliphatic low molecular weight crosslinkers are: hexahydrophthalic acid, hexahydroterephthalic acid, cis-1,3-cyclopentanedicarboxylic acid, cis-1,4-cyclohexanedicarboxylic acid, 1,5-cyclooctanedicarboxylic acid, hexahydrophthalic anhydride, methylhexahydrophthalic anhydride and 1,2-cyclohexanedicarboxylic anhydride.

The low molecular weight crosslinkers may be used individually or in combination in a total amount of usually 0.1 to 15 parts by weight, preferably 0.5 to 5 parts by weight, per 100 parts by weight of the epoxy group-containing copolymer. With particular preference, 0.7 to 1.3, more preferably 0.9 to 1.1 and especially preferably exactly one carboxyl group of the low molecular weight crosslinker is added per epoxy group of the epoxy group-containing copolymer,

The crosslinking aid used is at least one quaternary ammonium salt or phosphonium salt of the formula

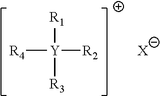

where Y is a nitrogen or phosphorus atom, each of the radicals R₁, R₂, R₃ and R₄ is mutually independently an alkyl, aryl, alkylaryl or polyoxyalkylene group having in each case between 1 and 25 carbon atoms, wherein two or three of these groups together with the nitrogen atom or the phosphorus atom may form a heterocyclic ring system, preferably is an alkyl, aryl, alkylaryl group having in each case between 1 and 10 carbon atoms and X⁻ is an anion derived from an inorganic or organic acid.

Preferred anions X⁻ are Cr⁻, Br⁻, I⁻, HSO₄⁻, H₂PO₄⁻, R₅COO⁻, R₅OSO₃⁻, R₅SO⁻ and R₅OPO₃⁻ where R₅ is an alkyl, aryl, alkylaryl group having in each case between 1 and 10 carbon atoms.

The quaternary ammonium salt is particularly preferably selected from tetraethylammonium bromide, tetrabutylammonium chloride, tetrabutylammonium bromide, tetrabutylammonium n-dodecyltrimethylammonium bromide, cetyldimethylbenzylammonium chloride, methylcetyldibenzylammonium bromide, cetyldimethylethylammonium bromide, cetyltrimethylammonium bromide, octadecyltrimethylammonium bromide, cetylpyridium chloride, cetylpyridium bromide, 1,8-diazabicyclo[5.4.0]undecene-7-methylammonium methosulphate, 1, 8-diazabicyclo[5.4.0]undecene-7-benzylammonium chloride, cetyltrimethylammonium alkylphenoxypoly(ethyleneoxy)ethyl phosphate, cetylpyridium sulphate, tetraethylammonium acetate, trimethylbenzylammonium benzoate, trimethylbenzylammonium p-toluenesulphonate and trimethylbenzylammonium borate. Very particular preference is given to using tributylammonium bromide and/or hexadecyltrimethylammonium bromide,

The quaternary phosphonium salt is particularly preferably selected from triphenylbenzylphosphonium chloride, triphenylbenzylphosphonium bromide, triphenylbenzylphosphonium iodide, triphenylmethoxymethylphosphonium chloride, triethylbenzylphosphonium chloride, tricyclohexylbenzylphosphonium chloride, trioctylmethylphosphonium dimethyl phosphate, tetrabutylphosphonium bromide and trioctylmethylphosphonium acetate.

The quaternary ammonium and phosphonium salts may be used individually or in combination in an amount of usually 0.1 to 10 parts by weight, preferably 0.5 to 5 parts by weight, per 100 parts by weight of the epoxy group-containing copolymer. The range stated above for the amount of these compounds, which is based on the epoxy group-containing copolymer, is determined with respect to the rate of vulcanization, the process stability and the mechanical properties and also the permanent shaping of the vulcanizate. If the amount is less than 0.1 parts by weight, the vulcanization usually barely proceeds and no vulcanizate is obtained with practical applicability. On the other hand, if the amount exceeds 10 parts by weight, the rate of vulcanization is extraordinarily rapid and the process stability of the mixture and also the ageing properties of the vulcanizate deteriorate.

It could be established, surprisingly, that the vulcanization properties are significantly improved in the crosslinking according to the invention and also the properties of the vulcanizate obtained thereby are considerably better compared to the prior art, particularly with respect to the lifetime under dynamic stress.

The vulcanizable composition according to the invention is preferably prepared by mixing the epoxy group-containing copolymer with the low molecular weight crosslinker, the crosslinking aid and optionally further chemicals and adjuvants commonly used in the rubber industry, e.g. fillers, plasticizers, antioxidants, processing aids and other additives with the aid of a customary mixing unit, e.g. a roil mill or internal mixer. In this case, both single-stage and multistage mixing processes can be applied.

Here, both the low molecular weight crosslinker and the crosslinking aid is preferably added in predispersed, polymer bound form. By adding as a master batch, a significantly better and at the same time a more gentle mixing is achieved, which reduces the risk of scorching and achieves better end product properties. In particular, the compression set is distinctly improved. The polymeric binder preferably used is Levapren®, particularly preferably Levapren® 400, 500 or 600. The low molecular weight crosslinker in this case is typically mixed into the carrier polymer in amounts of 50% by weight to 95% by weight, particularly preferably 65% by weight to 85% by weight, based on the total weight of the finished master batch3 The crosslinking aid is preferably mixed into the carrier polymer in amounts of 50% by weight to 95% by weight, particularly preferably 65% by weight to 85% by weight, based on the total weight of the finished master batch.

The use of a combined master batch comprising both low molecular weight crosslinker and the crosslinking aid is also possible.. In this case, the total amount of low molecular weight crosslinker and crosslinking aid is preferably 50% by weight to 95% by weight, particularly preferably 65% by weight to 85% by weight, based on the total weight of the finished master batch.

The vulcanizable compositions according to the invention preferably also comprise one or more fillers such as carbon black, aluminium hydroxide, magnesium hydroxide, talc, silica, calcium carbonate and kaolin (calcined) aluminium silicate, preferably carbon black, silica, calcined aluminium silicate, aluminium hydroxide and/or calcined kaolin,

The other additives include filler activators, light stabilizers, blowing agents, dyes, pigments, waxes, resins, and further or other additives known in the rubber industry (Ullmann's Encyclopedia of industrial Chemistry, VCH Verlagsgesellschaft mbH, D-69451 Weinheim, 1993, vol A 23 “Chemicals and Additives”, pp. 366-417).

Filler modifiers include e,g. organic shares such as vinyltrimethyloxysilane, vinyldimethoxymethylsilane, vinyltriethoxysilane, vinyltris(2-methoxyethoxy)silane, N-cyclohexyl-3-aminopropyltrimethoxysilane, 3-aminopropyltrimethoxysilane, methyltrimethoxysilane, methyltriethoxysilane, dimethyldimethoxysilane, dimethyldiethoxysilane, trimethylethoxysilane, isooctyltrimethoxysilane, isooctyltriethoxysilan, hexadecyltrimethoxysilane, (octadecyl)methyldimethoxysilane and epoxy group-containing shares such as 3-glycidoxypropyltrimethoxysilane or 3-glycidoxypropyltriethoxysilane. Further filler activators are, for example, interface-active substances such as triethanolamine, trimethylolpropane, hexanetriol, and polyethylene glycols with molecular weights of 74 to 10 000 g/mol. Particularly with fillers such as aluminium trihydroxides, which would interfere with or prevent the crosslinking in unmodified form, such modifiers are particularly preferably used. The amount of filler modifiers is typically 0 to 10 parts by weight, based on 100 parts by weight of the epoxy group-containing ethylene-vinyl acetate terpolymer.

As antioxidants, it is possible to add to the vulcanizable compositions all of those known to those skilled in the art, these being used typically in amounts of 0 to 5 parts by weight, preferably 0.5 to 3 parts by weight, based on 100 parts by weight of the epoxy group-containing ethylene-vinyl acetate copolymer. CDPA and TMQ are preferably used.

Suitable processing aids and/or mould release agents include, for example, saturated or partly unsaturated fatty adds and oleic adds and derivatives thereof (fatty acid esters, fatty acid salts, fatty alcohols, fatty acid amides). Furthermore, antiozonant waxes, e.g. Antilux, may be used in low metered additions as processing aids. These agents are used in amounts of 0 to 10 parts by weight, preferably 0 to 2 parts by weight, particularly preferably 0 to 1 part by weight, based on 100 parts by weight of the epoxy group-containing ethylene-vinyl acetate copolymer. Compared to compounds comprising conventional ethylene-vinyl acetate copolymers, the tackiness of the compounds based on the epoxy group-containing ethylene-vinyl acetate copolymers according to the invention is distinctly lower, therefore considerably lower metered additions are normally necessary. Frequently, processing aids can even be dispensed with completely. To further improve the demouldability, products which can be applied additionally to the mould surface may be used, for example products based on low molecular weight silicone compounds, products based on fluoropolymers and products based on phenol resins. For example, OBSH or ADC can be used as blowing agents.

Further possibilities include reinforcement with strength enhancers (fibres) of glass, in accordance with the teaching of U.S. Pat No. 4,626,721, and also reinforcement by means of cords, fabrics, fibres of aliphatic and aromatic polyamides (Nylon®, Aramid®), polyesters and natural fibre products.

The vulcanization of the epoxy group-containing copolymer according to the invention or the vulcanizable compositions containing these is typically carried out at a temperature in the range of 100 to 250° C., preferably 140 to 220° C., particularly preferably 160 to 200° C. Heat treatment can be carried out as needed after the vulcanization at a temperature of about 150 to 200° C. over 1 to 24 hours in order to improve the end product properties.

The invention also relates to the vulcanizates obtainable by said vulcanization. These exhibit very good values in the compression set test at room temperature and 150° C., high tensile strengths and good elongations at break.

The vulcanizates according to the invention typically have an elongation at break at RT of at least 150%, preferably at least 160%, particularly preferably at least 170% and particularly preferably at least 180%.

The vulcanizates according to the invention preferably have a compression set according to DIN ISO 815 168 h/150° C. of not more than 60%, preferably not more than 50% and particularly preferably not more than 40%.

The invention further relates to the use of the vulcanizable compositions according to the invention for preparing vulcanizates and shaped bodies comprising such vulcanizates, preferably shaped bodies selected from seals, insulation systems, cable sheaths, cable conduction layers, hoses or sound-damping materials and foamed shaped bodies, e.g. sound and thermal insulation foams, particularly foams which are vulcanized in air.

### EXAMPLES

Methods of Measurement:

The glass transition temperature, and also the onset and offset points thereof, are determined by means of Differential Scanning calorimetry (DSC) in accordance with ASTM E 1356-03 or to DIN 11357-2. The heating rate is 20 K/min.

The monomer content of the copolymers is determined by 1H-NMR (instrument: Bruker DPX400 with XWIN-NMR 3.1 software, measuring frequency 400 MHz).

The mooney viscosity values (ML (1+4) 100° C.) are determined in each case by means of a shearing disc viscometer in accordance with ISO 289 at 100° C.

The MDR (moving die rheometer) vulcanization profile and analytical data associated therewith were measured in an MDR 2000 Monsanto rheometer in accordance with ASTM D5289-95.

The sheets for the determination of the mechanical properties were crosslinked/vulcanized under the specified conditions between Teflon films in a vulcanizing press from Werner & Pfleiderer.

The Compression Set (CS) was measured at the specified temperature according to DIN ISO 815.

The Shore A hardness was measured in accordance with ASTM-D2240-81.

The tensile tests for determining the strain as a function of deformation were carried out in accordance with DIN 53504 or ASTM D412-80.

The tear propagation resistance was measured at room temperature on a Graves specimen in accordance with DIN 53515.

The tear analyzer measurements were conducted in air at a temperature of 120° C. using a tear analyzer from Coesfeld. Sample strips having a width of 15 mm, a thickness of about 1.5 mm and a free clamping length of 65 mm were used. The samples were provided with a razor having a 1 mm deep notch. For each test strip, the exact sample thickness was determined using a thickness gauge. The samples were uniaxially elongated with a pulse repetition rate of 4 Hz. This corresponds to a period duration of 0.25 seconds. The pulse having an amplitude of 2.5 to 6.5% of elongation was modulated with a sine wave with a frequency of 30 Hz. The end of the lifetime is attained when the crack depth is 10 min.

The hot-air ageing was conducted in accordance with DIN 53508/2000. The method 4.1.1 “Storage in a heating cabinet with positive ventilation” was applied.

The oil storage was conducted in accordance with DIN EN ISO 1817.

The abbreviations given in the tables below have the following meanings:

| | |
|---|---|
| “RT” | room temperature (23 ± 2° C.) |
| “TS” | tensile strength, measured at RT |
| “EB” | elongation at break, measured at RT |
| “M50” | modulus at 50% elongation, measured at RT |
| “M100” | modulus at 100% elongation, measured at RT |
| “M300” | modulus at 300% elongation, measured at RT |
| “S max” | is the maximum torque of the crosslinking isotherm |
| “t₁₀” | time to reach 10% of S max |
| “t₈₀” | time to reach 80% of S max |
| “t₉₀” | time to reach 90% of S max |

Substances Referred to by Commercial Name:

| | |
|---|---|
| Levapren ® 600 | Ethylene-vinyl acetate copolymer (VA content |
| | 60%) from Lanxess Deutschland GmbH |
| Sterling ® 142 | carbon black (commercial product from Cabot |
| | Corp.) |
| Rhenogran CaO-80 | dessicant from Rheinchemie Rheinau GmbH |
| Tetrabutyl- | (TBAB) commercial product from Sigma Aldrich |
| ammonium | Chemie |
| bromide GmbH | |
| Luvomaxx ® | ageing stabilizer from Lehmann and Voss & Co. |
| CDPA | KG |
| TAIC | Triallyl isocyanurate 100%, from Kettlitz |
| | GmbH |
| Uniplex DOS, | plasticizers from Unitex Chemical Corp. |
| Uniplex 546 | |
| Edenor C18 | Stearic acid from Oleo Solutions Ltd |
| Perkadox 14-40 | di(tert-butylperoxyisopropyl)benzene from |
| B-PD | AkzoNobel N.V. |
| Corax ® N550/30 | carbon black (commercial product from Orion |
| | Engineered Carbons GmbH) |
| Aflux 18 | processing aid from Rhein Chemie Rheinau |
| | GmbH |
| Stabaxol P | polycarbodiimide from Rhein Chemie Rheinau |
| | GmbH |
| Maglite DE | magnesium oxide from The HallStar Company |
| Vulkanox HS/LG | ageing stabilizer from Lanxess Deutschland GmbH |
| Glutaric acid | commercial product from Lanxess Deutschland |
| (technical grade) | GmbH |

1.1 Preparation of Epoxy Group-Containing Ethylene-Vinyl Acetate Copolymer

### Example 1 (T1)

The preparation was carried out in a 5 L stirred autoclave. For this purpose, 1978 g of a solution consisting of 691.0 g of tert-butanol, 1285.0 g of vinyl acetate, 2.0 g of glycidyl methacrylate and 252.5 g of an activator solution consisting of 2.50 g of ADVN and 250 g of vinyl acetate/tea butahol solution (vinyl acetate 20%) were drawn one after another into the 5 L reactor at RT. The reactor was inertized with nitrogen and then 1059 g of ethylene were injected. The temperature was raised to 61° C., establishing a pressure of approximately 380 bar. After half an hour, at which point the conversion was about 10 wt %, based on the vinyl acetate, a solution consisting of 122.2 g of tert-butanol, 156.3 g of vinyl acetate and 27.5 g of glycidyl methacrylate was metered into the reaction mixture at a rate of 0.6 g/min. Throughout the whole reaction period, the pressure was maintained at ca, 380 bar by injection of ethylene. After a reaction time of 10 h, the metering of ethylene was concluded and the polymer solution was expressed from the 5 L reactor into a stopping autoclave. After removal of the solvent and the residual monomers, 1586 g of glycidyl methacrylate-ethylene-vinyl acetate copolymer was obtained having a residual glycidyl methacrylate content of less than 100 mg/kg.

### Example 2 (T2)

In a 5 tank cascade with 30 L reactor volume, the first tank was charged with 0.00325 kg/h glycidyl methacrylate, 0.83 kg/h ethene, 1.50 kg/h of a 60% strength vinyl acetate solution in tert-butanol and 0.080 kg/h of an ADVN initiator solution (composition: 0.7% ADVN, 59.6% vinyl acetate, 39.6% tert-butanol) at 60° C. The tanks 2, 3, 4 and 5 were fed with 0.043 kg/h of a glycidyl methacrylate solution (composition: 37% t-BuOH, 55.5% vinyl acetate, 7.5% glycidyl methacrylate). The pressure was approximately 380 bar over the whole of the tank cascade. The process afforded 0.75 kg/h of glycidyl methacrylate-ethylene-vinyl acetate copolymer having a residual (monomeric) glycidyl methacrylate content of less than 100 mg/kg.

### Example 3 (T3)

The preparation was carried out in a 5 L stirred autoclave. For this purpose, 1983 g of a solution consisting of 693.0 g of tert-butanol, 1288.0 g of vinyl acetate, 2.0 g of glycidyl methacrylate and 252.5 g of an activator solution consisting of 2.50 g of ADVN and 250.0 g of vinyl acetate/tert-butanol solution (vinyl acetate 20%) were drawn one after another into the 5 L reactor at RT. The reactor was inertized with nitrogen and then 1062 g of ethylene were injected. The temperature was raised to 61° C., establishing a pressure of approximately 380 bar. After half an hour, a solution consisting of 122.2 g of tert-butanol, 151.8 g of vinyl acetate and 32.0 g of glycidyl methacrylate was metered into the reaction mixture at a rate of 0.68 g/min. Throughout the reaction, the pressure was maintained at approximately 380 bar by injection of ethylene.

After a reaction time of 7.5 h, the temperature was cautiously raised to 70° C. over the course of 30 minutes, and polymerization was carried out at temperature for a further hour. The ethylene feed was then concluded and the polymer solution was expressed slowly from the 5 L reactor into a stopping autoclave. After removal of the solvent and the residual monomers, 1407 g of glycidyl methacrylate ethylene-vinyl acetate copolymer was obtained having a residual (monomeric) glycidyl methacrylate content of less than 100 mg/kg.

### Example 4 (T4)

The preparation was carried out in a 5 L stirred autoclave. For this purpose, 1983 g of a solution consisting of 693.0 g of tert-butanol, 1288.0 g of vinyl acetate, 2.0 g of glycidyl methacrylate and 252.5 g of an activator solution consisting of 2.50 g of ADVN and 250 g of vinyl acetate/tert-butanol solution (vinyl acetate 20%) were drawn one after another into the 5 L reactor at RT. The reactor was inertized with nitrogen and then 1062 g of ethylene were injected. The temperature was raised to 61° C., establishing a pressure of approximately 380 bar. After half an hour, a solution consisting of 122.2 g of tert-butanol, 147.8 g of vinyl acetate and 36.0 g of glycidyl methacrylate was metered into the reaction mixture at a rate of 0.68 g/min. Throughout the whole reaction period, the pressure was maintained at ca, 380 bar by injection of ethylene.

After a reaction time of 7.5 h, the temperature was cautiously raised to 70° C. over the course of 30 minutes, and polymerization was carried out at temperature for a further hour. The ethylene feed was then halted and the polymer solution was expressed slowly from the 5 L reactor into a stopping autoclave. After removal of the solvent and the residual monomers, 1345 g of glycidyl methacrylate-ethylene-vinyl acetate copolymer was obtained having a residual (monomeric) glycidyl methacrylate content of less than 100 mg/kg.

### Example 5 (T5)

The preparation was carried out in a 5 L stirred autoclave. For this purpose, 1983 g of a solution consisting of 693.0 g of tert-butanol, 1288.0 g of vinyl acetate, 3.0 g of glycidyl methacrylate and 252.5 g of an activator solution consisting of 2.50 g of ADVN and 250.0 g of vinyl acetate/tert-butanol solution (vinyl acetate 20%) were drawn one after another into the 5 L reactor at RT. The reactor was inertized with nitrogen and then 1062 g of ethylene were injected. The temperature was raised to 61° C., establishing a pressure of approximately 380 bar. After half an hour, a solution consisting of 122.2 g of tert-butanol, 131.8 g of vinyl acetate and 52.0 g of glycidyl methacrylate was metered into the reaction mixture at a rate of 0.68 g/min. Throughout the whole reaction period, the pressure was maintained at ca. 380 bar by injection of ethylene.

After a reaction time of 7.5 h, the temperature was cautiously raised to 70° C. over the course of 30 minutes, and polymerization was carried out at temperature for a further hour. The ethylene feed was then halted and the polymer solution was expressed slowly from the 5 L reactor into a stopping autoclave. After removal of the solvent and the residual monomers, 1081 g of glycidyl methacrylate-ethylene-vinyl acetate copolymer was obtained having a residual (monomeric) glycidyl methacrylate content of less than 100 mg/kg.

### Comparative Example 6 (CT6)

The preparation was carried out in a 5 L stirred autoclave. For this purpose, 1985 g of a solution consisting of 693.0 g of tert-butanol, 1288.0 g of vinyl acetate, 4.0 g of glycidyl methacrylate and 252.5 g of an activator solution consisting of 2.50 g of ADV N and 250.0 g of vinyl acetate/tert-butanol solution (vinyl acetate 20%) were drawn one after another into the 5 L reactor at RT. The reactor was inertized with nitrogen and then 1062 g of ethylene were injected. The temperature was raised to 61° C., establishing a pressure of approximately 380 bar. After half an hour, at which point the conversion was ca. 10% by weight, based on the vinyl acetate, a solution consisting of 122.2 g of tert-butanol, 107.8 g of vinyl acetate and 76.0 g of glycidyl methacrylate was metered into the reaction mixture at a rate of 0.6 g/min. Throughout the whole reaction period, the pressure was maintained at ca. 380 bar by injection of ethylene.

After a reaction time of 10 h, the ethylene feed was halted and the polymer solution was expressed slowly from the 5 L reactor into a stopping autoclave. After removal of the solvent and the residual monomers, 1105 g of copolymers was obtained having a residual (monomeric) glycidyl methacrylate content of less than 100 mg/kg.

### Example 7 (T7)

The preparation was carried out in a 5 L stirred autoclave. For this purpose, 2822 g of a solution consisting of 874 g of tert-butanol, 1946 g of vinyl acetate, 2.0 g of glycidyl methacrylate and 251.2 g of an activator solution consisting of 1.20 g of ADV N and 250.0 g of vinyl acetate/tert-butanol solution (vinyl acetate 20%) were drawn one after another into the 5 L reactor at RT. The reactor was inertized with nitrogen and then 696 g of ethylene were injected. The temperature was raised to 61° C., establishing a pressure of approximately 380 bar. After half an hour, at which point the conversion was about 10% by weight, based on the vinyl acetate, a solution consisting of 157.5 g of tert-butanol, 251.2 g of vinyl acetate and 41.0 g of glycidyl methacrylate was metered into the reaction mixture at a rate of 0.88 g/min (ca. 8.5 h). Throughout the whole reaction period, the pressure was maintained at ca. 380 bar by injection of ethylene.

After a reaction time of 10 h, the ethylene feed was halted and the polymer solution was expressed slowly from the 5 L reactor into a stopping autoclave. After removal of the solvent and the residual monomers, 1762 g of glycidyl methacrylate-ethylene-vinyl acetate copolymer was obtained having a residual (monomeric) glycidyl methacrylate content of less than 100 mg/kg,

### Example 8 (T8)

The preparation was carried out in a 5 L stirred autoclave. For this purpose, 1560.5 g of a solution consisting of 882 g of tert-butanol, 677 g of vinyl acetate, 1.5 g of glycidyl methacrylate and 252.5 g of an activator solution consisting of 1.49 g of ADVN, 0.99 g of AIBN and 250.0 g of vinyl acetate/tert-butanol solution (vinyl acetate 20%) were drawn one after another into the 5 L reactor at RT. The reactor was inertized with nitrogen and then 1240 g of ethylene were injected. The temperature was raised to 62° C., establishing a pressure of approximately 380 bar. After half an hour, at which point the conversion was about 10% by weight, based on the vinyl acetate, a solution consisting of 228 g of tert-butanol, 127.0 g of vinyl acetate and 25.0 g of glycidyl methacrylate was metered into the reaction mixture at a rate of 0.75 g/min (ca. 8.5 h). Throughout the whole reaction period, the pressure was maintained at ca, 380 bar by injection of ethylene.

After 1.5 h, the temperature was increased to 65° C. After a further 1.5 h, the temperature was increased to 70° C. and after 5.5 h the polymerization temperature increased to 80° C. After a total reaction time of 10 h, the ethylene feed was halted and the polymer solution was expressed slowly from the 5 L reactor into a stopping autoclave. After removal of the solvent and the residual monomers, 1278 g of glycidyl methacrylate-ethylene-vinyl acetate copolymer was obtained having a residual (monomeric) glycidyl methacrylate content of less than 100 mg/kg.

### Example 9 (T9)

The epoxy-containing ethylene-vinyl acetate terpolymer was prepared in a 5 L stirred autoclave. For this purpose, 1984 g of a solution consisting of 693.0 g of tert-butanol, 1288.0 g of vinyl acetate, 3.0 g of glycidyl methacrylate and 252.5 g of an activator solution consisting of 2.50 g of 2,2′-azobis(2,4-dimethylvaleronitrile) and 250.0 g of vinyl acetate/tert-butanol solution (vinyl acetate 20%) were drawn one after another into the 5 L reactor at RT. The reactor was inertized with nitrogen and then 1062 g of ethylene were injected. The temperature was raised to 61° C., establishing a pressure of approximately 380 bar. After half an hour, a solution consisting of 122.2 g of tert-butanol, 134.8 g of vinyl acetate and 49.0 g of glycidyl methacrylate was metered into the reaction mixture at a rate of 0.68 g/min. Throughout the reaction, the pressure was maintained at approximately 380 bar by injection of ethylene.

After a reaction time of 9 h, the metering of ethylene was concluded and the polymer solution was expressed from the 5 L reactor into a stopping autoclave, which had been filled with 800 g of acetone. After slow venting, the polymer solution was released and solvent and residual monomer were removed under vacuum (75° C., 50 mbar, drying to constant weight). 1586 g of glycidyl methacrylate-ethylene-vinyl acetate terpolymer was obtained having a residual (monomeric) glycidyl methacrylate content of less than 100 mg/kg.

### Example 10 (T10)

The preparation was carried out analogously to Example 2, apart from the fact that the first tank was charged with glycidyl methacrylate at 0.0032 kg/h and tanks 2, 3, 4, 5 were charged with glycidyl methacrylate solution (composition: 37% t-BuOH, 55.5% vinyl acetate, 7.5% glycidyl methacrylate) at 0.041 kg/h. In this case, 0.76 kg/h of a glycidyl methacrylate-ethylene-vinyl acetate terpolymer was obtained having a residual (monomeric) GMA content of <100 mg/kg.

### Comparative Example 2 (CT2)

The preparation was carried out in a 5 L stirred autoclave. For this purpose, 2015 g of a solution consisting of 693.0 g of tert-butanol, 1288.0 g of vinyl acetate, 34.0 g of glycidyl methacrylate and 252.5 g of an activator solution consisting of 2.50 g of ADVN and 250.0 g of vinyl acetate/tert-butanol solution (vinyl acetate 20%) were drawn one after another into the 5 L reactor at RT. The reactor was inertized with nitrogen and then 1062 g of ethylene were injected. The temperature was raised to 61° C., establishing a pressure of approximately 380 bar. Polymerization took place for 10 h at approximately 380 bar. The pressure was established by metered addition of ethene and of a vinyl acetate/tert-butanol solution (60% vinyl acetate), observing an ethene/solution ratio of 1:2.

After a reaction time of 10 h, the feed was halted and the polymer solution was expressed slowly from the 5 L reactor into a stopping autoclave. After removal of the solvent and the residua/ monomers, 1570 g of glycidyl methacrylate-ethylene-vinyl acetate copolymer was obtained having a residual (monomeric) glycidyl methacrylate content of less than 100 mg/kg.

### Comparative Example 6′ (CT6′)

The preparation was carried out in a 5 L stirred autoclave. For this purpose, 2061 g of a solution consisting of 693.0 g of tert-butanol, 1288.0 g of vinyl acetate, 80.0 g of glycidyl methacrylate and 252.5 g of an activator solution consisting of 2.50 g of ADVN and 250.0 g of vinyl acetate/tert-butanol solution (vinyl acetate 20%) were drawn one after another into the 5 L reactor at RT. The reactor was inertized with nitrogen and then 1062 g of ethylene were injected. The temperature was raised to 61° C. establishing a pressure of approximately 380 bar. Polymerization took place for 10 h at approximately 380 bar. The pressure was established by metered addition of ethylene and of a vinyl acetate/tert-butanol solution (60% strength in terms of vinyl acetate), observing an ethylene/solution ratio of 1:2.

After a reaction time of 10 h, the feed was halted and the polymer solution was expressed slowly from the 5 L reactor into a stopping autoclave. After removal of the solvent and the residual monomers, 1199 g of glycidyl methacrylate-ethylene-vinyl acetate copolymer was obtained having a residual (monomeric) glycidyl methacrylate content of less than 100 mg/kg.

### Comparative Example 7 (CT7):

The preparation was carried out in a 5L stirred autoclave. For this purpose, 2794,0 g of a solution consisting of 850.0 g of tert-butanol, 1900.0 g of vinyl acetate, 44.0 g of glycidyl methacrylate and 251.2 g of an activator solution consisting of 1.2 g of ADVN and 250.0 g of vinyl acetate/tert-butanol solution (vinyl acetate 20%) were drawn one after another into the 5 L reactor at RT. The reactor was inertized with nitrogen and then 680 g of ethylene were injected. The temperature was raised to 61° C., establishing a pressure of approximately 380 bar. Polymerization took place for 10 h at approximately 380 bar. The pressure was established by metered addition of ethylene and of a vinyl acetate/tert-butanol solution (60% vinyl acetate), observing an ethylene/solution ratio of 1: 4.11.

After a reaction time of 10 h, the feed was halted and the polymer solution was expressed slowly from the 5 L reactor into a stopping autoclave. After removal of the solvent and the residual monomers, 1840.2 g of glycidyl methacrylate-ethylene-vinyl acetate copolymer was obtained having a residual (monomeric) glycidyl methacrylate content of less than 100 mg/kg.

### Comparative Example 8 (CT8)

The preparation was carried out in a 5 L stirred autoclave. For this purpose, 1585.5 g of a solution consisting of 882.0 g of tert-butanol, 677 g of vinyl acetate, 26.5 g of glycidyl methacrylate and 251.48 g of an activator solution consisting of 1.49 g of ADVN, 0.99 g of AIBN and 250.0 g of vinyl acetate/tert-butanol solution (vinyl acetate 20%) were drawn one after another into the 5 L reactor at RT. The reactor was inertized with nitrogen and then 1240 g of ethylene were injected. The temperature was raised to 62° C., establishing a pressure of approximately 380 bar. The pressure was established by metered addition of ethylene and of a vinyl acetate/tert-butanol solution (40% vinyl acetate), observing an ethylene/solution ratio of 1:1.45.

After 1.5 h, the temperature was increased to 65° C. After a further 1.5 h, the temperature was increased to 70° C. and after 5.5 h increased to 80° C. After a total reaction time of 10 h, the ethylene feed was halted and the polymer solution was expressed slowly from the 5 L reactor into a stopping autoclave.

After removal of the solvent and the residual monomers, 1103 g of glycidyl methacrylate-ethylene-vinyl acetate copolymer was obtained having a residual (monomeric) glycidyl methacrylate content of less than 100 mg/kg.

TABLE 1
Summary of the results

| | | | | ML(1 + 4@ | | | GMA | VA/ |
|---|---|---|---|---|---|---|---|---|
| | Mn | Mw | Mz | 100° C.) | Tg | Yield | [% by | [% by |
| Ex. | [g/mol] | [g/mol] | [g/mol] | [MU] | [° C.] | [g] | wt.] | wt.] |
| T1 | 78528 | 275316 | 657481 | 32.4 | −25 | 1586 | 1.8 | 55.8 |
| T2 | 67385 | 219033 | 567337 | 23 | −24 | 750 g/h | 2.1 | 58.3 |
| T3 | 60848 | 212855 | 502514 | 23.6 | −25 | 1407 | 2.3 | 58.6 |
| T4 | 56432 | 173900 | 434261 | 17.1 | −24 | 1345 | 2.8 | 58.9 |
| T5 | 47730 | 124567 | 250089 | 17.0 | −24 | 1081 | 4.7 | 56.3 |
| CT6 | 55024 | 148717 | 320262 | 16.1 | −22 | 1105 | 6.9 | 54.9 |
| T7 | 72154 | 221050 | 484881 | 24.2 | −6 | 1762 | 2.1 | 73.2 |
| T8 | 64378 | 255711 | 640281 | 33.5 | −28 | 1278 | 2.0 | 40.0 |
| T9 | 56242 | 188962 | 432932 | 21.6 | −25 | 1586 | 3.6 | 56.6 |
| T10 | 68665 | 226004 | 595841 | 22.8 | −25 | 760 g/h | 1.9 | 58.6 |
| CT2 | 63741 | 213822 | 492939 | 24.3 | −24 | 1570 | 2.1 | 57.8 |
| CT6′ | 57707 | 178206 | 434950 | 20.9 | −24 | 1199 | 6.4 | 56.3 |
| CT7 | 75789 | 229324 | 511811 | 29.1 | −6 | 1840 | 2.4 | 74.0 |
| CT8 | 57228 | 187045 | 418537 | 24.4 | −29 | 1103 | 2.4 | 39.4 |

2. Vulcanizable Mixtures and Vulcanizates

The components specified in Table 2 were in each case added to 100 parts of the glycidyl methacrylate-ethylene-vinyl acetate copolymer used and vulcanizable compositions were prepared by mixing on the roller for 10 minutes.

TABLE 2
Composition of the vulcanizable mixture

| Vulcanizable mixture | M2a | M3a | M4a | M5a | CM6a | CM2a |
|---|---|---|---|---|---|---|
| Copolymer used | T2 | T3 | T4 | T5 | CT6 | CT2 |
| GMA content of | 2.1 | 2.3 | 2.8 | 4.7 | 6.9 | 2.1 |
| the copolymer | | | | | | |
| (% by wt) | | | | | | |
| Corax (parts) | 50 | 50 | 50 | 50 | 50 | 50 |
| Luvomaxx | 1.5 | 1.5 | 1.5 | 1.5 | 1.5 | 1.5 |
| CDPA (parts) | | | | | | |
| Glutaric acid (parts) | 0.98 | 1.07 | 1.3 | 2.18 | 3.21 | 0.98 |
| Tetrabutylammonium | 1.36 | 1.49 | 1.81 | 3.05 | 4.47 | 1.36 |
| bromide (parts) | | | | | | |

The vulcanization profile of the mixtures was determined in the moving die rheometer at 180° C./30 minutes. The results are listed in table 3.

TABLE 3
Vulcanization profile in the MDR (180° C./30 minutes)

| | Vulcanizable mixture | | | | | |
|---|---|---|---|---|---|---|
| | M2a | M3a | M4a | M5a | CM6a | CM2a |
| S min (dNm) | 0.77 | 0.78 | 0.64 | 0.47 | 0.83 | 1.14 |
| S max (dNm) | 12.77 | 15.12 | 17.98 | 26.27 | 41.35 | 4.23 |
| t₁₀ (sec) | 50 | 56 | 48 | 35 | 31 | 19 |
| T₈₀ (sec) | 153 | 152 | 125 | 91 | 74 | 234 |
| T₉₀ (sec) | 197 | 192 | 152 | 112 | 91 | 435 |

It was shown that the crosslinking level S max (dNm) of compositions comprising copolymers in which GMA was added during the polymerization is significantly better than in compositions comprising copolymers in which all the GMA was added at the beginning of the polymerization.

TABLE 4
Vulcanizate properties

| | | Vulcanizate | | | | | |
|---|---|---|---|---|---|---|---|
| | | M2a | M3a | M4a | M5a | CM6a | CM2a |
| | | Vulcanization time (min in the press at 180° C.) | | | | | |
| | | 12 | 12 | 12 | 12 | 12 | 12 |
| TS | MPa | 16.10 | 15.50 | 15.60 | 13.6 | 15.30 | 1.8 |
| EB | % | 447.0 | 390.0 | 352.0 | 182.0 | 131.0 | 632 |
| M50 | MPa | 2.10 | 2.00 | 2.40 | 3.8 | 5.20 | 1.4 |
| M100 | MPa | 4.40 | 4.50 | 5.30 | 8.5 | 12.40 | 1.6 |
| M300 | MPa | 12.30 | 12.90 | 13.90 | — | — | 1.7 |
| Hard- | Shore | 69 | 67 | 69 | 76 | 78 | 61 |
| ness | A | | | | | | |
| CS (168 | % | 40 | 32 | 33 | 28 | 25 | 97 |
| h/150° C.) | | | | | | | |

The inventive mixtures led to very advantageous vulcanizate properties with respect to elongation at break. tensile strength, hardness and compression set (CS).

Crosslinking of Unfilled Vulcanizable Compositions

The components specified in Table 5 were in each case added to 100 parts of the glycidyl methacrylate-ethylene-vinyl acetate copolymer used and vulcanizable compositions were prepared by mixing on the roller for 10 minutes. The glutaric acid was used stoichiometrically in this case, i.e. in a molar ratio (glutaric acid to epoxy groups of the copolymer) of 1:2, The molar ratio of epoxy groups of the copolymer to tetrabutylammonium bromide was 3.5: 1.

TABLE 5
Unfilled composition for gel measurement

| | M2b | CM2b | CM6b | CM6′b | M7b | CM7b | M8b | CM8b |
|---|---|---|---|---|---|---|---|---|
| Copolymer used | T2 | CT2 | CT6 | CT6′ | T7 | CT7 | T8 | CT8 |
| GMA content of | 2.1 | 2.1 | 6.9 | 6.4 | 2.1 | 2.4 | 2.0 | 2.4 |
| the copolymer | | | | | | | | |
| (% by wt) | | | | | | | | |
| Glutaric acid (parts) | 0.98 | 0.98 | 3.21 | 2.97 | 0.98 | 1.12 | 0.93 | 1.12 |
| Tetrabutylammonium | 1.36 | 1.36 | 4.47 | 4.15 | 1.36 | 1.56 | 1.30 | 1.56 |
| bromide (parts) | | | | | | | | |

The vulcanization profile of the mixtures was determined in the moving die rheometer 180′C/30 minutes. The results are listed in table 6.

TABLE 6
Vulcanization profile of unfilled compositions in the MDR (180° C./30 minutes)

| Vulcanizate | M2b | CM2b | CM6b | CM6′b | M7b | CM7b | M8b | CM8b |
|---|---|---|---|---|---|---|---|---|
| S min (dNm) | 0.13 | 0.15 | 0.14 | 0.22 | 0.11 | 0.09 | 0.21 | 0.20 |
| S max (dNsn) | 3.6 | 0.49 | 11.88 | 0.60 | 5.06 | 0.45 | 4.43 | 0.63 |
| t₁₀ (sec) | 46 | — | 29 | — | 35 | — | 111 | — |
| T₈₀ (sec) | 144 | — | 93 | — | 72 | — | 317 | — |
| T₉₀(sec) | 188 | — | 134 | — | 86 | — | 382 | — |

The unfilled vulcanizable compositions according to Table 5 was each vulcanized at 180° C. for 12 minutes. The gel content of the individual vulcanizates was then measured, for which 0.2 g of copolymer was dissolved as far as possible in 20 ml of toluene by shaking on a shaker at room temperature for 24 h and the solution was subsequently centrifuged at 25 000 rpm, radius 11 cm, for 45 min. The supernatant solvent was removed without loss of gel. The remaining gel was dried to constant weight at 60° C. in a drying cabinet and weighed. The gel content is stated in % by weight calculated from:

Gel content=(finial gel weight/polymer starting weight)*100%

TABLE 6
Gel content of unfilled compounds after vulcanization at 180° C.

| Vulcanizate | M2b | CM2b | CM6b | Cm6′b | M7b | CM7b | M8b | CM8b |
|---|---|---|---|---|---|---|---|---|
| Gel content | 90.7 | 19.9 | 97.1 | 34.0 | 96.9 | 30.9 | 93.3 | 23.7 |
| (% by wt) | | | | | | | | |

Comparison with Peroxide Crosslinked EVM

The polymers were prepared according to the formulations shown in Table 8 in a type GK 1.5 E internal mixer from Harburg-Freudenberger. The fill level was 70%, the temperature 30° C. the speed 40 rpm, the ram pressure 8 bar.

### Comparative Example 10 (CT 10)

Polymer, fillers, plasticizers and other constituents apart from the peroxide were filled into the mixer, the ram closed and the mixture was then mixed for 3 minutes, then the ram vented and swept, then the ram was reclosed and the mixture was ejected on reaching a mixing temperature of 100° C.

The Perkadox 14-40 BPD was then mixed in on the roller at 30° C.

### Examples 11 and 12 (T11 and T12)

Polymer, fillers, plasticizers and other constituents apart from the glutaric acid and the TBAB were filled into the mixer, the ram closed and the mixture was then mixed for 3 minutes, then the ram vented and swept, the glutaric acid and the TBAB were then added after increasing the speed to 70 rpm and then the ram was reclosed and the mixture was ejected on reaching a mixing temperature of 115° C. The mixture was then coded on the roller at 30° C.

TABLE 8
Composition of the vulcanizable mixtures (all data in pph)

| Component | CT10 | T11 | T12 |
|---|---|---|---|
| Levapren 600 | 100 | | |
| Copolymer T10 (1.9% GMA) | | 100 | |
| Copolymer T9 (3.6% GMA) | | | 100 |
| Sterling 142 | 85 | 85 | 85 |
| Uniplex 546 | 7.5 | 7.5 | 7.5 |
| Uniplex DOS | 7.5 | 7.5 | 7.5 |
| Aflux 18 | 1.5 | | |
| Edenor C 18 98-100 | 2.0 | | |
| Rhenogran CaO-80 | 3.0 | | |
| Stabaxol P | 0.5 | | |
| Vulkanox HS/LG | 1.5 | | |
| Maglite DE | 2.0 | | |
| Antilux 110 | | 2 | 2 |
| Luvomaxx CDPA | | 1.5 | 1.5 |
| TAIC | 2.0 | | |
| Perkadox 14-40 B-PD | 6.0 | | |
| Glutaric acid technical grade | | 0.88 | 1.67 |
| Tetrabutylammonium | | 1.23 | 2.33 |
| bromide | | | |
| Total | 218.50 | 205.61 | 207.50 |

The properties of the vulcanizable mixtures (without prior heat treatment measured) are shown in Table 9:

TABLE 9
Properties of the vulcanizable mixtures

| | CT10 | T11 | T12 |
|---|---|---|---|
| Mooney viscosity | 45 | 47 | 42 |
| ML(1 + 4) 100° C. (MU) | | | |
| S′ min (dNm) | 0.75 | 1.05 | 1.07 |
| S′ max (dNm) | 26.11 | 13.60 | 27.11 |
| t90 (min) | 5.98 | 4.22 | 2.40 |
| Vulcanization time (min | 12 | 6 | 6 |
| in the press at 180° C. | | | |

The properties of the resulting vulcenizates are shown in Table 10.

TABLE 10
Vulcanizate properties

| | CT10 | T11 | T12 |
|---|---|---|---|
| CS 22 h/150° C. (%) | 21 | 19 | 13 |
| CS 24 h/175° C. (%) | 44 | 30 | 25 |
| Tensile strength (MPa) | 15.8 | 11.9 | 13.5 |
| Elongation at break (%) | 155 | 316 | 164 |
| M 100 (MPa) | 11.0 | 7.0 | 10.8 |
| Shore A hardness | 77 | 75 | 78 |
| Tear propagation | 12 | 20 | 13 |
| resistance DIN 53515 | | | |
| (N/mm) | | | |

Vulcanizate properties after hot-air ageing (168 hours at 150° C.)

| | | | |
|---|---|---|---|
| Tensile strength (MPa) | 15 | 16.1 | 18.7 |
| Elongation at break (%) | 165 | 160 | 114 |
| M 100 (MPa) | 12.1 | 11.4 | 16.9 |
| Shore A hardness | 89 | 87 | 85 |

Vulcanizate properties after storage in oil IRM 903 (168 hours at 150° C.)

| | | | |
|---|---|---|---|
| Tensile strength (MPa) | 13.3 | 12.3 | 12.8 |
| Elongation at break (%) | 148 | 214 | 147 |
| M 100 (MPa) | 9 | 6.4 | 9.8 |
| Shore A hardness | 54 | 51 | 62 |

The dynamic tensile properties were additionally investigated in the Tear Analyzer. The results are shown in FIG. 3 and FIG. 4. It was shown here that the cracking rate of the vulcanizates according to the invention is distinctly lower and therefore the lifetime of the dynamically stressed shaped bodies consisting of such vulcanizates is distinctly higher compared to peroxide vulcanized ethylene-vinyl acetate copolymers. Far greater are the advantages of the vulcanizates according to the invention compared to those which were obtained by polycarboxylic acid crosslinking of non-inventive epoxy-containing ethylene-vinyl acetate copolymers. Here, vulcanizates of the vulcanizable mixtures comprising glutaric acid and the copolymers CT2 or CT6 showed cracking rates and lifetimes which were far worse than that of the peroxide crosslinked vulcanizate based on Levapren 600.

3. 2D Chromatography

Compositions comprising copolymers with similar GMA content were analyzed which were differentiated between compositions comprising copolymers in which GMA was added during the polymerization arid compositions comprising copolymers in which all of the GMA was added at the beginning of the polymerization.

The analysis was performed by coupled HPLC/GPC (2D chromatography) which is commercially operated by PSS Polymer Standards Service GmbH, In der Dalheimer Wiese 5, D-65120 Mainz, Germany.

The following parameters were chosen for the 2D chromatography:

1. Samples

Solvent: THF/CHCl₃ 50/50 v/v

Concentration: 20 g/L

Filtration: via a singe filter with a pore size of 0.45 μm

Injection volume: 20 μL

2. HPLC Dimension

Separating column: Stainless steel column —50 mm/8.0 mm ID, PSS ANIT, 10 μm

Column temperature: 30° C.

Eluent: CH and THF

Flow rate: 0.2 mil/min

Gradient: from CH/THF 70/30 to CH/THF 21/79 in 210 minutes

3. GPC Dimension

Separating column: Stainless steel column—50 mm/20.0 mm ID, P55 SDV, 10 μm

column temperature: RT

Eluent: THF

Flow rate: 5 ml/min

Detector: ELSD, NT 90° C., ET 100° C., GF 1.5 SLM

4. Switching Valve

Loop volume: 200 μl.

Elution time/inject: 2 min

Transfer injections: 106

5. Under the conditions selected, only 50% of the HPLC eluate is transferred from the first dimension to the second dimension.

6. GPC evaluation of the soluble sample fractions, based on polystyrene equivalents.

7. Abbreviations

ANIT Acrylonitrile polymer

CH Cyclohexane

ELSD Evaporative light scattering detector

ET Evaporator temperature

GF Gas Flow

GPC Gel permeation chromatography

HPLC High Performance Liquid Chromatography

ID Internal diameter

NT Nebulizer temperature

PSS Polymer Standard Service

RT Room temperature

SDV Styrene-divinylbenzene

SLM Standard litres per minute

THF Tetrahydrofuran

It was shown in this case that copolymers in which ail of the GMA was added at the beginning of the polymerization show at least two polymer fractions in the chromatogram (cf. FIG. 2), whereas by contrast copolymers in which GMA was added after the beginning of the polymerization show essentially only one polymer fraction in the chromatogram (cf. FIG. 1).

1. A vulcanizable composition comprising:
an epoxy group-containing copolymer having a content of copolymerized vinyl acetate of at least 35% by weight, a content of copolymerized ethylene of at least 10% by weight, and a content of copolymerized epoxy group-containing monomers of 0.1 to 6.2% by weight, in each case based on the epoxy group-containing copolymer, wherein the total proportion of monomers incorporated which are not vinyl acetate, ethylene and epoxy group-containing monomers is less than 15% by weight, based on the epoxy group-containing copolymer, and wherein a mixture of the epoxy group-containing copolymer having a half molar amount of glutaric acid based on the epoxy groups present in the epoxy group-containing copolymer and a 3.5-fold molar amount of tetrabutylammonium bromide based on the epoxy groups present in the epoxy group-containing copolymer, after 12 minutes of vulcanization at 18M, has a gel content of at least 50% by weight;
a crosslinking aid; and
a crosslinker having a molar mass of less than 2000 g/mol, in the form of a polycarboxylic acid, a polycarboxylic ester, a polycarboxylic anhydride, or a mixture thereof.

2. The vulcanizable composition according to claim 1, wherein the content of copolymerized vinyl acetate is at least 40% by weight, preferably at least 45% by weight, particularly preferably at least 50% by weight, based in each case on the epoxy group-containing copolymer.

3. The vulcanizable composition according to claim 1, wherein the content of copolymerized ethylene is at least 15% by weight, preferably at east 20% by weight and particularly preferably at least 25% by weight, based in each case on the epoxy group-containing copolymer.

4. The vulcanizable composition according to claim 1, wherein the content of copolymerized epoxy group-containing monomers is from 0.1 to 5.8% by weight, preferably from 0.5 to 5.0% by weight, particularly preferably from 0.8 to 4.5% by weight, based in each case on the epoxy group-containing copolymer.

5. The vulcanizable composition according to claim 1, wherein the copolymerized epoxy group-containing monomer is selected from the group consisting of 2-ethylglycidyl acrylate, 2-ethylglycidyl methacrylate, 2-(n-propyl)glycidyl acrylate, 2-(n-propyl)glycidyl methacrylate, 2-(n-butyl)glycidyl acrylate, 2-(n-butyl)glycidyl methacrylate, glycidyl methacrylate, glycidylmethyl acrylate, glycidylmethyl methacrylate, glycidyl acrylate, (3′,4′-epoxyheptyl)-2-ethyl acrylate, (3′,4′-epoxyheptyl)-2-ethyl methacrylate, (6′,7′-epoxyheptyl) acrylate, (6′,7′-epoxyheptyl) methacrylate, allyl glycidyl ether, allyl 3,4-epoxyheptyl ether, 6,7-epoxyheptyl allyl ether, vinyl glycidyl ether, vinyl 3,4-epoxyheptyl ether, 3,4-epoxyheptyl vinyl ether, 6,7-epoxyheptyl vinyl ether, o-vinylbenzyl glycidyl ether, m-vinylbenzyl glycidyl ether, p-vinylbenzyl glycidyl ether, 3-vinylcyclohexene oxide and mixtures thereof, preferably from the group consisting of glycidyl methacrylate, glycidylmethyl acrylate, glycidylmethyl methacrylate, glycidyl acrylate, and mixtures thereof and particularly preferably from the group consisting of glycidyl acrylate, glycidyl methacrylate and mixtures thereof.

6. The vulcanizable composition according to claim 1, wherein the crosslinker is an aromatic or aliphatic di-, tri- or tetracarboxylic acid, preferably an aliphatic di-, tri- or tetracarboxylic acid, particularly preferably an aliphatic dicarboxylic acid and most preferably glutaric acid, dodecanedioic acid or adipic acid.

7. The vulcanizable composition according to claim 1, wherein the crosslinking aid is one or more compounds selected from tetraethylammonium bromide, tetrabutylammonium chloride, tetrabutylammonium bromide, tetrabutylammonium iodide, n-dodecyltrimethylammonium bromide, cetyldimethylbenzylammonium chloride, methylcetyldibenzylammonium bromide, cetyldimethylethylammonium bromide, cetyltrimethylammonium bromide, octadecyltrimethylammonium bromide, cetylpyridium chloride, cetylpyridium bromide, 1,8-diazabicyclo[5.4.0]undecene-7-methylammonium methosulphate, 1,8-diazabicyclo[5.4.0]undecene-7-benzylammonium chloride, cetyltrimethylammonium alkylphenoxypoly(ethyleneoxy)ethyl phosphate, cetylpyridium sulphate, tetraethylammonium acetate, trimethylbenzylammonium benzoate, trimethylbenzylammonium p-toluenesulphonate and trimethylbenzylammonium borate, triphenylbenzylphosphonium chloride, triphenylbenzylphosphonium bromide, triphenylbenzylphosphonium iodide, triphenylmethoxymethylphosphonium chloride, triethylbenzylphosphonium chloride, tricyclohexylbenzylphosphonium chloride, trioctylmethylphosphonium dimethyl phosphate, tetrabutylphosphonium bromide and trioctylmethylphosphonium acetate, preferably tributylammonium bromide and/or hexadecyltrimethylammonium bromide.

8. The vulcanizable composition according to claim 1, wherein the epoxy group-containing copolymer has a mooney viscosity (ML (1+4) 100° C.)≧15 mooney units (MU), preferably a 17 mooney units, particularly preferably ≧20 mooney units.

9. A process for vulcanization of vulcanizable compositions according to claim 1, the process comprising crosslinking the epoxy group-containing copolymer or a vulcanizable composition containing the epoxy group-containing copolymer at a temperature of 100 to 250° C., preferably 140 to 220° C., particularly preferably 160 to 200° C.

10. A vulcanizate obtained by vulcanization of the vulcanizable compositions according to claim 1.

11. The vulcanizate according to claim 10, wherein the vulcanizates have an elongation at break at RT of at least 150%, preferably at least 160%, particularly preferably at least 170% and particularly preferably at least 180%.

12. The vulcanizate according to claim 10, wherein the vulcanizates have a compression set according to DIN ISO 815 168 h/150° C. of not more than 60%, preferably not more than 50% and particularly preferably not more than 40%.

13. An unfoamed and/or foamed shaped body, comprising vulcanizates according to claim 10.

14. The vulcanizable composition according to claim 1, wherein the mixture of the epoxy group-containing copolymer has a gel content of at least 80% by weight.

15. The vulcanizable composition according to claim 1, wherein the mixture of the epoxy group-containing copolymer has a gel content of 90 to 100% by weight.

16. The vulcanizable composition according to claim 1, wherein:
the content of copolymerized vinyl acetate is at least 40% by weight based on the epoxy group-containing copolymer;
the content of copolymerized ethylene is at least 15% by weight based on the epoxy group-containing copolymer; and
the content of copolymerized epoxy group-containing monomers is 0.1 to 5.8% by weight based on the epoxy group-containing copolymer.

17. The vulcanizable composition according to claim 16, wherein:
the epoxy group-containing copolymer has a mooney viscosity (ML (1+4) 100° C.)≧15 mooney units;
the copolymerized epoxy group-containing monomer is selected from the group consisting of 2-ethylglycidyl acrylate, 2-ethylglycidyl methacrylate, 2-(n-propyl)glycidyl acrylate, 2-(n-propyl)glycidyl methacrylate, 2-(n-butyl)glycidyl acrylate, 2-(n-butyl)glycidyl methacrylate, glycidyl methacrylate, glycidylmethyl acrylate, glycidylmethyl methacrylate, glycidyl acrylate, (3′,4′-epoxyheptyl)-2-ethyl acrylate, (3′,4′-epoxyheptyl)-2-ethyl methacrylate, (6′,7′-epoxyheptyl) acrylate, (6′,7′-epoxyheptyl) methacrylate, allyl glycidyl ether, allyl 3,4-epoxyheptyl ether, 6,7-epoxyheptyl allyl ether, vinyl glycidyl ether, vinyl 3,4-epoxyheptyl ether, 3,4-epoxyheptyl vinyl ether, 6,7-epoxyheptyl vinyl ether, o-vinylbenzyl glycidyl ether, m-vinylbenzyl glycidyl ether, p-vinylbenzyl glycidyl ether, 3-vinylcyclohexene oxide and mixtures thereof;
the crosslinker is an aromatic or aliphatic di-, tri- or tetracarboxylic acid, preferably an aliphatic di-, tri- or tetracarboxylic acid, particularly preferably an aliphatic dicarboxylic acid and most preferably glutaric acid, dodecanedioic acid or adipic acid; and
the crosslinking aid is one or more compounds selected from tetraethylammonium bromide, tetrabutylammonium chloride, tetrabutylammonium bromide, tetrabutylammonium iodide, n-dodecyltrimethylammonium bromide, cetyldimethylbenzylammonium chloride, methylcetyldibenzylammonium bromide, cetyldimethylethylammonium bromide, cetyltrimethylammonium bromide, octadecyltrimethylammonium bromide, cetylpyridium chloride, cetylpyridium bromide, 1,8-diazabicyclo[5.4.0]undecene-7-methylammonium methosulphate, 1,8-diazabicyclo[5.4.0]undecene-7-benzylammonium chloride, cetyltrimethylammonium alkylphenoxypoly(ethyleneoxy)ethyl phosphate, cetylpyridium sulphate, tetraethylammonium acetate, trimethylbenzylammonium benzoate, trimethylbenzylammonium p-toluenesulphonate and trimethylbenzylammonium borate, triphenylbenzylphosphonium chloride, triphenylbenzylphosphonium bromide, triphenylbenzylphosphonium iodide, triphenylmethoxymethylphosphonium chloride, triethylbenzylphosphonium chloride, tricyclohexylbenzylphosphonium chloride, trioctylmethylphosphonium dimethyl phosphate, tetrabutylphosphonium bromide, and trioctylmethylphosphonium acetate.

18. The vulcanizable composition according to claim 1, wherein:
the content of copolymerized vinyl acetate is at least 50% by weight based on the epoxy group-containing copolymer;
the content of copolymerized ethylene is at least 25% by weight based on the epoxy group-containing copolymer; and
the content of copolymerized epoxy group-containing monomers is 0.8 to 4.5% by weight based on the epoxy group-containing copolymer.

19. The vulcanizable composition according to claim 18, wherein:
the epoxy group-containing copolymer has a mooney viscosity (ML (1+4) 100° C.)≧20 mooney units;
the copolymerized epoxy group-containing monomer is glycidyl acrylate, glycidyl methacrylate, or mixtures thereof;
the crosslinker is glutaric acid, dodecanedioic acid, adipic acid, or mixtures thereof; and
the crosslinking aid is tributylammonium bromide and/or hexadecyltrimethylammonium bromide.

20. The vulcanizable composition according to claim 19, wherein the mixture of the epoxy group-containing copolymer has a gel content of 90 to 100% by weight.
